(19) United States
(12) Patent Application Publication
(10) Pub. No.: US 2025/0046833 A1
(43) Pub. Date: Feb. 6, 2025

(54) AIR-COOLED FUEL CELL SYSTEM

(71) Applicant: TOYOTA JIDOSHA KABUSHIKI KAISHA, Toyota-shi (JP)

(72) Inventors: Nobuaki NONOYAMA, Chiryu-shi (JP); Takahiro UMEHARA, Susono-shi (JP)

(73) Assignee: TOYOTA JIDOSHA KABUSHIKI KAISHA, Toyota-shi (JP)

(21) Appl. No.: 18/786,800

(22) Filed: Jul. 29, 2024

(30) Foreign Application Priority Data
Jul. 31, 2023 (JP) 2023-124072

(51) Int. Cl. H01M 8/04014; H01M 8/04007; H01M 8/04223; H01M 8/04302; H01M 8/04746

(52) U.S. Cl. CPC H01M 8/04014; H01M 8/04067; H01M 8/04231; H01M 8/04302; H01M 8/04753; H01M 8/04768

(57) ABSTRACT

To provide a fuel cell system capable of suppressing generation of an abnormal potential of a fuel cell. An air-cooled fuel cell system, wherein the fuel cell system comprises a fuel cell, a hydrogen system for supplying hydrogen to the fuel cell, a reaction air system for supplying reaction air to the fuel cell, and a cooling air system for supplying cooling air to the fuel cell; wherein the fuel cell comprises a reaction air flow path and a cooling air flow path and has a flow path structure in which the reaction air and the cooling air are independent.

### CROSS-REFERENCE

This application claims priority to Japanese Patent Application No. 2023-124072 filed on Jul. 31, 2023, incorporated herein by reference in its entirety.

### TECHNICAL FIELD

The present disclosure relates to an air-cooled fuel cell system.

### BACKGROUND

Various studies have been proposed for fuel cells (FC) as disclosed in Patent Documents 1 to 3.
Patent Document 1: Japanese Patent Application Laid-Open (JP-A) No. 2005-216783
Patent Document 2: JP-A No. 2009-158203
Patent Document 3: JP-A No. 2022-185247

In the case of an open air-cooled fuel cell, air is present at the cathode since the cathode is open during the period from the previous system shutdown to the current system startup. During this period, an abnormal potential is generated in the fuel cell, which causes deterioration of the fuel cell.

### SUMMARY

The disclosure was achieved in light of the above circumstances. An object of the disclosure is to provide an air-cooled fuel cell system capable of suppressing the generation of an abnormal potential in a fuel cell.

In the first embodiment of the present disclosure, there is provided an air-cooled fuel cell system,

wherein the fuel cell system comprises a fuel cell, a hydrogen system for supplying hydrogen to the fuel cell, a reaction air system for supplying reaction air to the fuel cell, and a cooling air system for supplying cooling air to the fuel cell;

wherein the fuel cell comprises a reaction air flow path and a cooling air flow path and has a flow path structure in which the reaction air and the cooling air are independent;

wherein the fuel cell system is configured to shut off a cathode of the fuel cell and an anode thereof from the outside of the fuel cell system when the fuel cell system is shut down;

wherein the fuel cell system is configured to start supplying the hydrogen to the fuel cell and supplying the cooling air to the fuel cell while stopping the supply of the reaction air to the fuel cell when the fuel cell system starts up; and

wherein the fuel cell system is configured to start supplying the reaction air to the fuel cell, after a lapse of a predetermined time from start-up of the fuel cell.

According to the second embodiment of the present disclosure, in the first embodiment, the reaction air system may comprise a reaction air blowing device; the cooling air system may comprise a cooling air blowing device; and a hydrogen discharge flow path of the hydrogen system may merge with a cooling air discharge flow path of the cooling air system.

According to the third embodiment of the present disclosure, in the first embodiment, the fuel cell system may comprise an electrical system, and the fuel cell system may be configured to connect the fuel cell to a power line of the electrical system when the fuel cell system starts up.

According to the fourth embodiment of the present disclosure, in the first embodiment, the hydrogen system may comprise a hydrogen pump.

The present disclosure can suppress generation of an abnormal potential in the fuel cell.

### BRIEF DESCRIPTION OF THE DRAWINGS

In the accompanying drawings,

FIG. 1 is a schematic exploded perspective view showing an example of a unit cell of the fuel cell included in the fuel cell system of the present disclosure;

FIG. 2 is a schematic perspective view showing an example of a fuel cell stack included in the fuel cell system of the present disclosure;

FIG. 3 is a system configuration diagram illustrating an example of the fuel cell system of the present disclosure;

FIG. 4 is a circuit diagram illustrating an example of the electrical system included in the fuel cell system of the present disclosure;

FIG. 5 is a flowchart showing an example of the control of the fuel cell system of the present disclosure; and

FIG. 6 is a flowchart showing another example of the control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like. In the present disclosure, air as an oxidant gas is referred to as reaction air, and air as a cooling gas is referred to as cooling air.

In the present disclosure, there is provided an air-cooled fuel cell system,

wherein the fuel cell system comprises a fuel cell, a hydrogen system for supplying hydrogen to the fuel cell, a reaction air system for supplying reaction air to the fuel cell, and a cooling air system for supplying cooling air to the fuel cell;

wherein the fuel cell comprises a reaction air flow path and a cooling air flow path and has a flow path structure in which the reaction air and the cooling air are independent;

wherein the fuel cell system is configured to shut off a cathode of the fuel cell and an anode thereof from the outside of the fuel cell system when the fuel cell system is shut down;

wherein the fuel cell system is configured to start supplying the hydrogen to the fuel cell and supplying the cooling air to the fuel cell while stopping the supply of the reaction air to the fuel cell when the fuel cell system starts up; and

wherein the fuel cell system is configured to start supplying the reaction air to the fuel cell, after a lapse of a predetermined time from start-up of the fuel cell.

When air is introduced into the cathode and hydrogen is introduced into anode the without a current flowing therethrough, the potential of the unit cell of the fuel cell becomes a high potential (about 0.95-1.05V). In this condition, the deterioration of the fuel cell progresses, albeit gently. In addition, an oxide film is formed on Pt catalyst, which causes deterioration in the performance of the catalyst. In order to avoid this, the potential of the unit cells of the fuel cell may be constantly operated at a 0.85V or lower.

In a general open air-cooled fuel cell, it is difficult to seal the air system with a large opening of the air system, and oxygen is present at both poles when the system is started, so that generation of a high-potential state of the fuel cell cannot be avoided.

Even when the cathode is sealed, it is necessary to dilute the exhaust hydrogen by replacing hydrogen-based nitrogen, oxygen, moisture, and the like at the time of system startup. If the reaction air blower such as an air blower is turned ON and the reaction air is introduced into the cathode prior to the introduction of the hydrogen for dilution, the high potential condition or the abnormal potential is generated.

The present disclosure relates to performance improvement of an air-cooled fuel cell, and proposes a configuration and a method for smoothly starting a system while preventing generation of an abnormal potential of the fuel cell, deterioration of the fuel cell, and the like. A fuel cell having a flow path structure in which the reaction air and the cooling air are independent is activated by a predetermined procedure. When the system is started up, the supply of the reaction air is stopped, and hydrogen replacement of the anode can be performed while quickly purging nitrogen, oxygen, moisture, and the like of the hydrogen system, thereby suppressing generation of an abnormal potential of the fuel cell.

Hydrogen exhausted to the outside of the fuel cell system at the start-up of the system can be diluted with cooling air.

The fuel cell system includes a fuel cell in which hydrogen and air react to generate power, a hydrogen system in which hydrogen necessary for power generation of the fuel cell is supplied to the fuel cell, a reaction air system in which reaction air is supplied to the fuel cell, and a cooling air system in which cooling air for cooling heat generated by power generation is supplied to the fuel cell.

The fuel cell may have only one unit cell of the fuel cell, or may be a fuel cell stack which is a stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may have corrugated cooling fins that serve as the cooling air flow path in each unit cell.

The fuel cell stack may include a current collector plate, a pressure plate, and the like at an end portion in the stacking direction.

The unit cell of the fuel cell may have a reaction air flow path (oxidant gas flow path) and a cooling air flow path (cooling gas flow path) having a flow path structure in which the reaction air and the cooling air are independent, and may further have a hydrogen gas flow path (fuel gas flow path).

The flow path structure in which the reaction air and the cooling air are independent means that there is no sharing of air between the flow paths from the supply of air to the fuel cell to the discharge of air from the fuel cell. The flow path for discharging the air discharged from the fuel cell to the outside of the fuel cell system may be independent or may not be independent.

The unit cell may have a flow path structure for flowing the reaction air and the cooling air so that the flow of the cooling air and the flow of the reaction air intersect each other in a plan view. The flow of cooling air and the flow of reaction air may intersect or be orthogonal.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are an anode (fuel electrode or hydrogen electrode) and a cathode (oxygen electrode or air electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a hydrogen gas flow path on a surface on the side of the power generation unit, and may have a groove that serves as a cooling air flow path on a surface on the side opposite to the power generation unit.

The cathode separator may have a groove that serves as a reaction air flow path on a surface on the side of the power generation unit, and may have a groove that serves as a cooling air flow path on a surface on the side opposite to the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The fuel cell system may include a control device. The control device may control the entire fuel cell system by controlling the reaction air system, the hydrogen system, the cooling air system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The reaction air system supplies reaction air as an oxidant gas to the fuel cell and regulates a flow rate of the reaction air.

The hydrogen system supplies hydrogen as a fuel gas to the fuel cell and adjusts the flow rate of the hydrogen. The hydrogen system may include a hydrogen tank, a hydrogen inlet valve, an injector, a gas-liquid separator, a hydrogen purge valve, an ejector for hydrogen circulation, a hydrogen pump for hydrogen circulation, and a hydrogen pipe.

The cooling air system supplies cooling air as a cooling gas to the fuel cell and regulates a flow rate of the cooling air.

The reaction air system may have an inlet-side sealing valve at the inlet of the reaction air of the fuel cell and an outlet-side sealing valve at the outlet of the reaction air of the fuel cell.

In the present disclosure, the fuel cell has a flow path structure in which the reaction air and the cooling air are independent from each other, and in the reaction air system, a valve (an inlet-side sealing valve and an outlet-side sealing valve) is installed at the inlet and outlet of the reaction air of the fuel cell, so that the fuel cell can seal the cathode of the fuel cell with a smaller volume as compared with a case where the reaction air and the cooling air have a common flow path structure.

The reaction air system may have a reaction air blowing device, the cooling air system may have a cooling air blowing device, and the hydrogen discharge flow path of the hydrogen system may merge with the cooling air discharge flow path of the cooling air system.

The hydrogen-based hydrogen discharge flow path may further include a merging portion that can merge with the reaction air discharge flow path of the reaction air system.

The fuel cell system has an independent blowing device in the reaction air system and the cooling air system, and the hydrogen discharge flow path merges with the cooling air discharge flow path, so that the fuel cell system stops the reaction air blowing device and drives the cooling air blowing device at the outer of hydrogen replacement of the hydrogen system at the time of system startup, so that the exhausted hydrogen can be diluted with the cooling air and discharged to the outside of the fuel cell system.

The reaction air blowing device and the cooling air blowing device may be an air compressor, an air pump, an air blower, an air fan, and the like, respectively.

The reaction air system may have a reaction air inlet for taking the reaction air from the outside of the fuel cell system, and the reaction air inlet may be provided with a pressure loss body such as an air filter.

The cooling air system may have a cooling air inlet for taking cooling air from the outside of the fuel cell system, and a pressure loss body such as an air filter may be provided in the cooling air inlet.

The fuel cell system shuts off the cathode and anode of the fuel cell from the outside of the fuel cell system when the system is shut down. The fuel cell system starts supplying hydrogen to the fuel cell and supplying cooling air to the fuel cell while stopping the supply of the reaction air to the fuel cell at system startup. The fuel cell system starts supplying the reaction air to the fuel cell after a predetermined time has elapsed from the time of system startup. The cathode may be shut off from the outside of the fuel cell system by closing the reaction air inlet-side sealing valve and the reaction air outlet-side sealing valve. The shut-off of the anode from the outside of the fuel cell system may be performed by closing the hydrogen inlet valve and the hydrogen purge valve.

By activating the fuel cell system according to the following activation sequence, deterioration of the fuel cell can be prevented.

### (1) Boot Sequence 1

Hydrogen-based hydrogen replacement is performed from a condition where the fuel cell system is stopped while the reaction air inlet-side sealing valve, the reaction air outlet-side sealing valve, the hydrogen inlet valve, and the hydrogen purge valve are all closed, and the cathode and the anode are shut off from the outside of the fuel cell system. When hydrogen purging of the hydrogen system is performed by opening and closing the hydrogen purge valve, the cooling air may be introduced into the fuel cell and the hydrogen dilution may be performed without introducing the reaction air into the fuel cell while stopping the blowing unit of the reaction air system and maintaining the sealing of the cathode, while the cooling fan is turned ON only for the cooling air system.

### (2) Boot Sequence 2

After a predetermined period of time has elapsed from the start of the system, the reaction air inlet-side sealing valve and the reaction air outlet-side sealing valve are opened, and the reaction air is introduced into the fuel cell using the air blower of the reaction air system as an ON, thereby starting the power generation of the fuel cell. The predetermined time may be set as appropriate and may be set in advance.

A fuel cell having a flow path structure in which the reaction air and the cooling air are independent from each other is used, and a reaction air inlet-side sealing valve and a reaction air outlet-side sealing valve are provided in the reaction air system, and the cathode is formed into a sealed structure, thereby preventing oxygen from entering the fuel cell when the system is stopped. Unlike conventional air-cooled fuel cells, the anode can be oxygen-free at startup. From this condition, (1) hydrogen substitution of the anode is performed before the reaction air is introduced into the cathode in the starting sequence 1. In order to perform hydrogen purging of the hydrogen system, dilution exhaust by air is required. At this time, by providing an independent blowing device in the cooling air system, by moving only the cooling fan of the cooling air system without moving the blowing device of the reaction air system, while maintaining the sealing of the cathode, it is possible to safely perform the hydrogen exhaust. After the hydrogen substitution of the anode is completed, (2) by introducing the reaction air into the cathode in the starting sequence 2, power generation of the fuel cell can be started without generating an abnormal potential.

The fuel cell system may comprise an electrical system.

The electrical system may comprise a diode on a power line with the fuel cell and may further comprise a relay for the fuel cell. By having the diode, generation of a reverse current from the power line side to the fuel cell can be avoided.

The fuel cell system may connect the fuel cell to a power line of the electrical system at system startup. A power consumption absorbing device such as a secondary battery or a capacitor is connected to the power line.

In the case of a configuration in which a diode and a relay are installed in a power line of an electric system, the fuel cell and the power line are connected by a relay before (1) execution of the start sequence 1 or (2) execution of the start sequence 2. It is possible to prevent a high potential from being generated during hydrogen-introduction or during reaction-air introduction, and to provide a V1≤V2. When the fuel cell and the power line are not connected by relays and the fuel cell is introduced into the fuel cell while the fuel cell is in the open circuit state, the cell voltage of the fuel cell becomes a high potential (0.9V exceeding) of the open circuit voltage (OCV), and deterioration of the fuel cell progresses. By connecting the power line and the fuel cell via a diode prior to the introduction of the reactant air into the fuel cell, the potential of the fuel cell can be maintained at a V2 or less while avoiding the generation of a reverse current. V2 may be adjusted by a power absorbing device such as a connected battery or capacitor so that the cell voltage is less than 0.85V.

The hydrogen system may have a hydrogen pump for circulation. By providing a hydrogen pump, hydrogen substitution and drainage can be efficiently performed with a small amount of hydrogen. The hydrogen concentration in the fuel cell can be quickly homogenized, and degradation due to local hydrogen deficiency can be prevented.

In the start sequence 2, the hydrogen system circulation may be performed by a hydrogen pump to homogenize the hydrogen concentration of the hydrogen system.

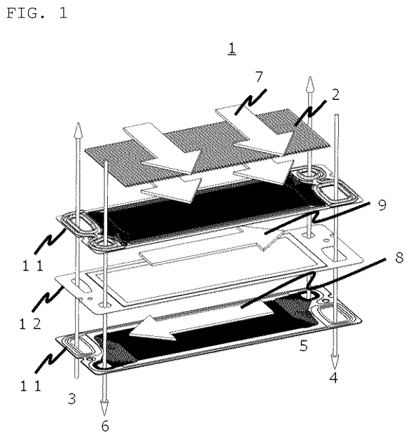

FIG. 1 is a schematic exploded perspective view showing an example of a unit cell of the fuel cell included in the fuel cell system of the present disclosure.

The unit cell 1 shown in FIG. 1 includes a cooling fin (cooling air flow path) 2 serving as a flow path for cooling air (cooling gas) 7, a reaction air inlet 3, a reaction air outlet 4, a hydrogen gas inlet 5, a hydrogen gas outlet 6, two separators 11, a MEA sandwiched between the two separators 11, and a resin frame 12. As shown in FIG. 1, the unit cell 1 of the fuel cell has a flow path structure in which the reaction air 9 and the cooling air 7 are independent from each other.

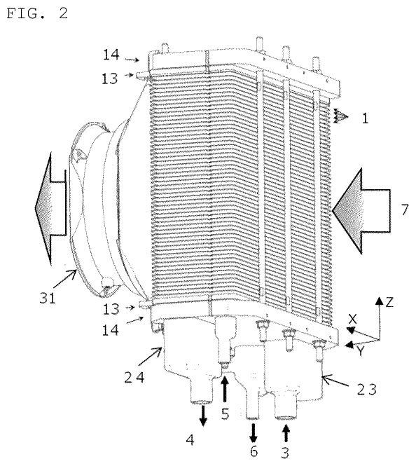

FIG. 2 is a schematic perspective view showing an example of a fuel cell stack included in the fuel cell system of the present disclosure.

The fuel cell stack shown in FIG. 2 is a stacked body in which a plurality of unit cells 1 are stacked, and includes a current collector plate 13 and a pressure plate 14 at both ends in the stacking direction.

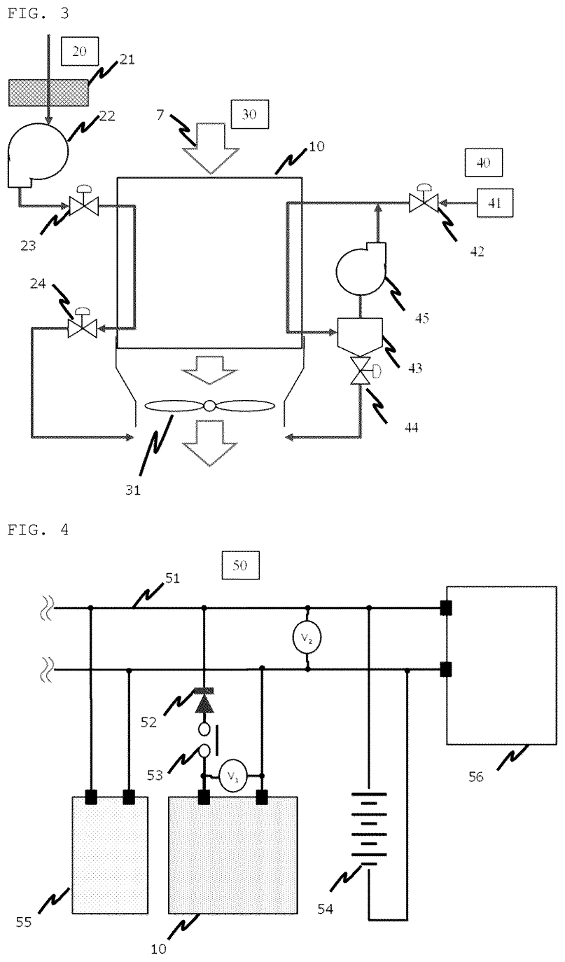

FIG. 3 is a system configuration diagram illustrating an example of the fuel cell system of the present disclosure.

The fuel cell system shown in FIG. 3 includes a fuel cell stack 10, a reaction air system 20, a cooling air system 30, and a hydrogen system 40. The reaction air system 20 includes a reaction air intake port 21, an air blower 22, an inlet-side sealing valve 23, and an outlet-side sealing valve 24. The cooling air system 30 includes a cooling fan 31. The hydrogen system 40 includes a hydrogen tank 41, a hydrogen inlet valve 42, a gas-liquid separator 43, a hydrogen purge valve 44, and a hydrogen pump 45. The fuel cell system shown in FIG. 3 includes sealing valves 23 and 24 at the entrance and exit of the reaction air system 20, and independent blowing device 22 and 31 for the reaction air system 20 and the cooling air system 30.

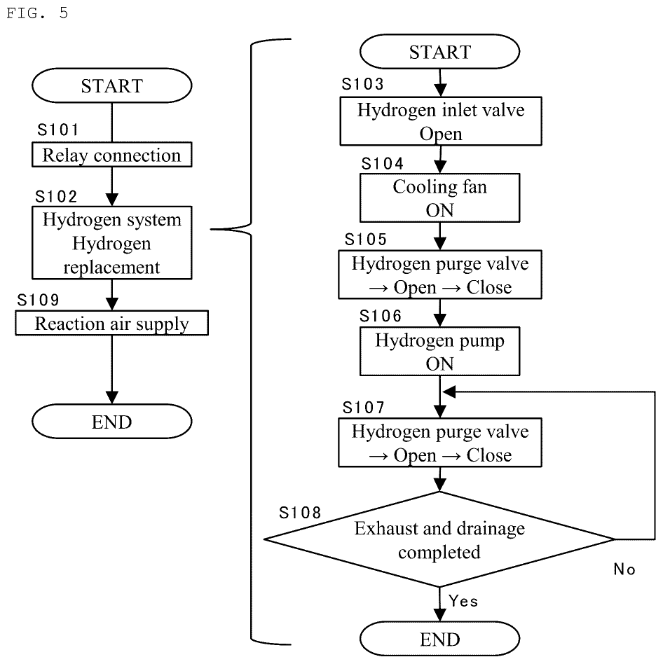

FIG. 4 is a circuit diagram illustrating an example of the electrical system included in the fuel cell system of the present disclosure.

The electrical system 50 shown in FIG. 4 includes a power line 51, a diode 52, a relay 53, power consumption absorbing device 54 such as a battery/capacitor, auxiliary equipment 55, and power consumption equipment 56.

By installing the diode 52 on the power line 51, the fuel cell stack 10 is connected to the power line 51 at the time of recovery control, so that it is possible to shorten the time of recovery control while avoiding the generation of a reverse current from the power line 51 side to the fuel cell stack 10.

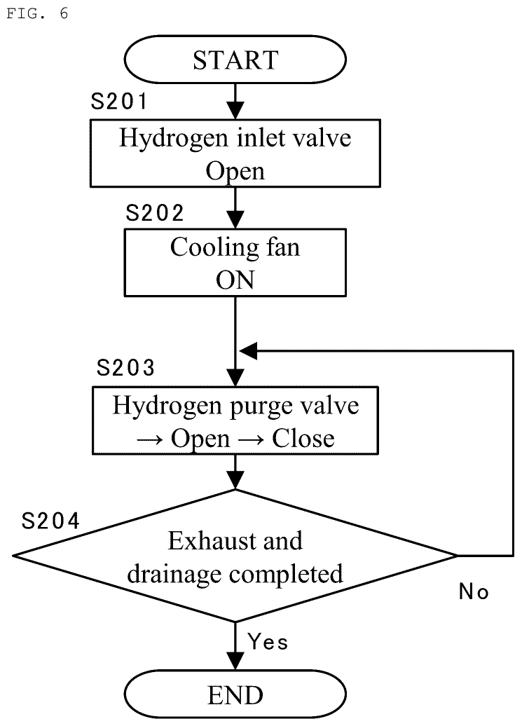

FIG. 5 is a flowchart showing an example of the control of the fuel cell system of the present disclosure.

FIG. 5 is a fuel cell system configuration including a hydrogen pump, a relay, and a diode for performing an activation sequence.

After the condition cell is left for a while, the fuel cell system is started up from the fuel cell voltage V1≈0V.

Connect the fuel cell relay (S101). Since it is a fuel-cell-voltage V1<V2 and is diode-filled, no current flows.

Hydrogen substitution of the hydrogen system is performed (S102). Open the hydrogen inlet valve and introduce hydrogen into the anode (S103). The hydrogen inlet valve may be opened and closed as appropriate, such as to create a pulsed airflow. If the cathode is oxygen-filled during long-term shutdown, the fuel cell may be at a high potential (OCV≈1.0V) if the relays are not connected, and degradation of the fuel cell may progress.

The cooling fans of the cooling-air system must be turned ON in advance to dilute the exhaust gases (S104). When the flow path structure in which the reaction air and the cooling air are independent and the reaction air system and the cooling air system do not have the independent air blowing device, the reaction air is passed through the cathode, and the cathode becomes a high potential or an abnormal potential. In order to avoid a high potential or an abnormal potential, an additional device such as a three-way valve for bypassing the cathode and flowing air is required. Since hydrogen may be diluted up to the exhaust port in contact with the outside of the fuel cell system, ON-OFF timing of the cooling-air fan may be slightly before or after the opening and closing of the hydrogen purge valve.

Open the hydrogen purge valve and discharge nitrogen, oxygen, moisture, etc. accumulated during system shutdown (S105).

The hydrogen pump is turned ON to homogenize the hydrogen content in the anode (S106). Open and close the hydrogen purge valve and drain the exhaust water even while the hydrogen pump is turned ON, for example, when liquid water has accumulated during the shutdown (S107).

When the exhaust water is completed and the anode is filled with high concentration hydrogen, hydrogen substitution is completed (S108).

Open the inlet/outlet sealing valve of the reaction air system and introduce air to the cathode (S109). At this time, if the relays are not connected, the fuel cell becomes a high potential (OCV≈1.0V), and degradation of the fuel cell may progress. Although the fuel cell is temporarily at a high potential, the connection of the relay may be after the reaction air supply.

A predetermined amount of reaction air necessary for power generation is fed to the cathode by an air blower of a reaction air system, and power generation of the fuel cell is started.

FIG. 6 is a flowchart showing another example of the control of the fuel cell system of the present disclosure.

FIG. 6 is a fuel cell system configuration that does not include a hydrogen pump, and hydrogen replacement is performed.

After the condition cell is left for a while, the fuel cell system is started up from the fuel cell voltage V1≈0V.

Hydrogen substitution of the hydrogen system is performed. Open the hydrogen inlet valve and introduce hydrogen into the anode (S201).

The cooling fans of the cooling-air system must be turned ON in advance to dilute the exhaust gases (S202).

Open and close the hydrogen purge valve to discharge nitrogen, oxygen, moisture, etc. accumulated during system shutdown (S203).

When the exhaust water is completed and the anode is filled with high concentration hydrogen, hydrogen substitution is completed (S204).

### REFERENCE SIGNS LIST

1. Unit cell
2. Cooling fin (cooling air flow path)
3. Reaction air inlet
4. Reaction air outlet
5. Hydrogen gas inlet
6. Hydrogen gas outlet
7. Cooling air (cooling gas)
8. Hydrogen gas
9. Reaction air
10. Fuel cell stack
11. Separator
12. MEA, resin frame
13. Current collector
14. Pressure plate
20. Reactive air system
21. Reaction air inlet
22. Air blower
23. Inlet side sealing valve
24. Outlet side sealing valve
30. Cooling air system
31. Cooling fan
40. Hydrogen system
41. Hydrogen tank
42. Hydrogen inlet valve
43. Gas separator
44. Hydrogen purge valve
45. Hydrogen pump
50. Electric system
51. Power line
52. Diode
53. Relay
54. Power consumption absorbing device
55. Auxiliaries
56. Power consuming equipment

1. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the fuel cell system is configured to shut off a cathode of the fuel cell and an anode thereof from the outside of the fuel cell system when the fuel cell system is shut down;
wherein the fuel cell system is configured to start supplying the hydrogen to the fuel cell and supplying the cooling air to the fuel cell while stopping the supply of the reaction air to the fuel cell when the fuel cell system starts up; and
wherein the fuel cell system is configured to start supplying the reaction air to the fuel cell, after a lapse of a predetermined time from the start-up of the fuel cell system.

2. The fuel cell system according to claim 1,
wherein the reaction air system comprises a reaction air blowing device;
wherein the cooling air system comprises a cooling air blowing device; and
wherein a hydrogen discharge flow path of the hydrogen system merges with a cooling air discharge flow path of the cooling air system.

3. The fuel cell system according to claim 1,
wherein the fuel cell system comprises an electrical system, and
wherein the fuel cell system is configured to connect the fuel cell to a power line of the electrical system when the fuel cell system starts up.

4. The fuel cell system according to claim 1, wherein the hydrogen system comprises a hydrogen pump.

5. The fuel cell system according to claim 1,
wherein the fuel cell comprises at least one of unit cell,
wherein the unit cell comprises an anode separator, a power generation unit, and a cathode separator, in this order,
wherein the cathode separator comprises the reaction air flow path on the side of the power generation unit, and comprises the cooling air flow path on the side opposite to the power generation unit.

6. The fuel cell system according to claim 5,
wherein the unit cell comprises a corrugated cooling fin as the cooling air flow path.

7. The fuel cell system according to claim 1,
wherein the fuel cell system is configured to start supplying the hydrogen to the fuel cell and supplying the cooling air to the fuel cell while stopping the supply of the reaction air to the fuel cell when the fuel cell system starts up, and then the fuel cell system is configured to start hydrogen purging of the hydrogen system.
